(19) United States
(12) Patent Application Publication
(10) Pub. No.: US 2006/0225488 A1
(43) Pub. Date: Oct. 12, 2006

(54) Humidity sensor for measuring supersaturated water vapor utilizing a mini-heater

(75) Inventor: Jamie W. Speldrich, Freeport, IL (US)

Correspondence Address: Kris T. Fredrick;Honeywell International, Inc., 101 Columbia Rd., P.O. Box 2245, Morristown, NJ, 07962, US

(73) Assignee: Honeywell International, Inc.

(21) Appl. No.: 11/103,135

(22) Filed: Apr. 9, 2005

(51) Int. Cl. G01N 7/00

(52) U.S. Cl. 73/29.01

(57) ABSTRACT

A humidity sensing apparatus and method includes a humidity sensor capable of measuring relative humidity and a heater located about and proximate to the humidity sensor wherein a portion of the heater comprises a material that permits a diffusion of air through the material of the heater. A sensing area is generally formed between the heater and the humidity sensor, wherein the heater provides a heated environment within the sensing area in order to evaporate water droplets that form within the sensing area and reduce relative humidity to a measurable level and measure supersaturated air within the sensing area.

### TECHNICAL FIELD

Embodiments are generally related to sensing devices and components thereof. Embodiments additionally relate to humidity sensors and techniques for measuring water vapor. Embodiments also relate to heater components utilized in association with humidity sensors for measuring water vapor and humidity.

### BACKGROUND OF THE INVENTION

Humidity sensors are but one class of sensors that are utilized in a variety of commercial and industrial applications. Humidity sensors are utilized to measure water vapor, which is an important factor in maintaining consumer and industrial products. Modern manufacturing processes, for example, generally require measurement of moisture contents corresponding to dew points between −40° C. and 18° C., or a relative humidity between 1% and 100%. There is also a need for a durable, compact, efficient moisture detector that can be used effectively in these processes to measure very small moisture content in gaseous atmospheres. Another area where humidity sensors find usefulness, for example, is in the area of fuel cells, such as hydrogen fuel cells.

Humidity can be measured by a number of techniques. In a semiconductor-based system, for example, humidity can be measured based upon the reversible water absorption characteristics of polymeric materials. The absorption of water into a sensor structure causes a number of physical changes in the active polymer. These physical changes can be transduced into electrical signals which are related to the water concentration in the polymer and which in turn are related to the relative humidity in the air surrounding the polymer.

Two of the most common physical changes are the change in resistance and the change in dielectric constant, which can be respectively translated into a resistance change and a capacitance change. It has been found, however, that elements utilized as resistive components suffer from the disadvantage that there is an inherent dissipation effect caused by the dissipation of heat due to the current flow in the elements necessary to make a resistance measurement. The result is erroneous readings, among other problems.

Elements constructed to approximate a pure capacitance avoid the disadvantages of the resistive elements. It is important in the construction of capacitive elements, however, to avoid the problems that can arise with certain constructions for such elements. In addition, there can also be inaccuracy incurred at high relative humidity values where high water content causes problems due to excessive stress and the resulting mechanical shifts in the components of the element. By making the component parts of the element thin, it has been found that the above-mentioned problems can be avoided and the capacitance type element can provide a fast, precise measurement of the relative humidity content over an extreme range of humidity as well as over an extreme range of temperature and pressure and other environmental variables.

The ability to measure relative humidity (RH) is an important feature of a humidity sensor. An example of an RH sensor is disclosed in U.S. Pat. No. 6,724,612, “Relative humidity sensor with integrated signal conditioning,” which is assigned to Honeywell International Inc. and issued to Davis et al on Apr. 20, 2004. U.S. Pat. No. 6,724,612 is incorporated herein by reference.

One of the problems with RH sensors is such devices can measure RH up to 100%, but at levels higher than 100% water droplets generally form in a suspension (e.g., fog) and sensor fails to operate due to material limitations. To date, a satisfactory solution has not been found for adequately measuring RH at levels higher than 100%. The embodiments disclosed herein address this long felt need.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the embodiments to provide for an improved relative humidity sensing device.

It is another aspect of the embodiments to provide for heater components utilized in association with humidity sensors.

It is yet another aspect of the embodiments to provide for a humidity sensing apparatus that measures relative humidity greater than 100%.

It is a further aspect of the embodiments to provide for a sensing device for measuring supersaturated water vapor utilizing a mini-heater.

The aforementioned aspects of the invention and other objectives and advantages can now be achieved as described herein. A humidity sensing apparatus and method includes a humidity sensor capable of measuring relative humidity and a heater located about and proximate to the humidity sensor wherein a portion of the heater comprises a material that permits a diffusion of air through the material of the heater. A sensing area is generally formed between the heater and the humidity sensor, wherein the heater provides a heated environment within the sensing area in order to evaporate water droplets that form within the sensing area and reduce relative humidity to a measurable level and measure supersaturated air within the sensing area.

The humidity sensor is capable of measuring relative humidity within a range of 0% to 100%. Thus, the humidity sensor, the heater and the sensing area enable measurement of a relative humidity greater than 100% within the sensing area by providing a controlled, heater environment within a vicinity of the sensing area. The heater can be configured to comprise a topside heater formed above the humidity sensor a bottom-side heater located below the humidity sensor, wherein the topside heater comprises the material that permits diffusion of air through the material of the heater.

The topside heater is associated with a thermistor and the bottom-side heater is associated with a thermistor. Additionally, a circuit board can be connected to at least one heater support component for supporting the topside heater and the bottom-side heater, while at least one insulating zone can be formed between the circuit board and the heater support component.

The heater support component can be configured to include a first frame formed from a thermally conducting material and a second frame supporting a filter material associated with the heater. Additionally, a plurality of low-thermal conductivity electrical leads can be utilized to electrically connect the humidity sensor to the circuit board, thereby allowing data to be transferred between the humidity sensor and the circuit board. Additionally, an ambient temperature sensor can be associated with the humidity sensor. An unheated reference temperature sensor is also associated with the humidity sensor, such that the ambient temperature sensor and the unheated reference temperature sensor are utilized to relative humidity sensing data generated by the humidity sensor.

In accordance with an alternative embodiment, the humidity sensor can be configured from a ceramic material having a plurality of holes formed therein which minimize airflow thereof, such that the ceramic material is nonconductive and heats and vaporizes water droplets passing therethrough, thereby reducing the relative humidity to the measurable level.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a side view of a humidity sensor apparatus that can be implemented in accordance with a preferred embodiment;

FIG. 2 illustrates a side view of a humidity sensor apparatus that can be implemented in accordance with another embodiment; and

FIG. 3 illustrates a side view of a humidity sensor apparatus that can be implemented in accordance with an alternative embodiment.

### DETAILED DESCRIPTION

The particular values and configurations discussed in these non-limiting examples can be varied and are cited merely to illustrate at least one embodiment and are not intended to limit the scope thereof.

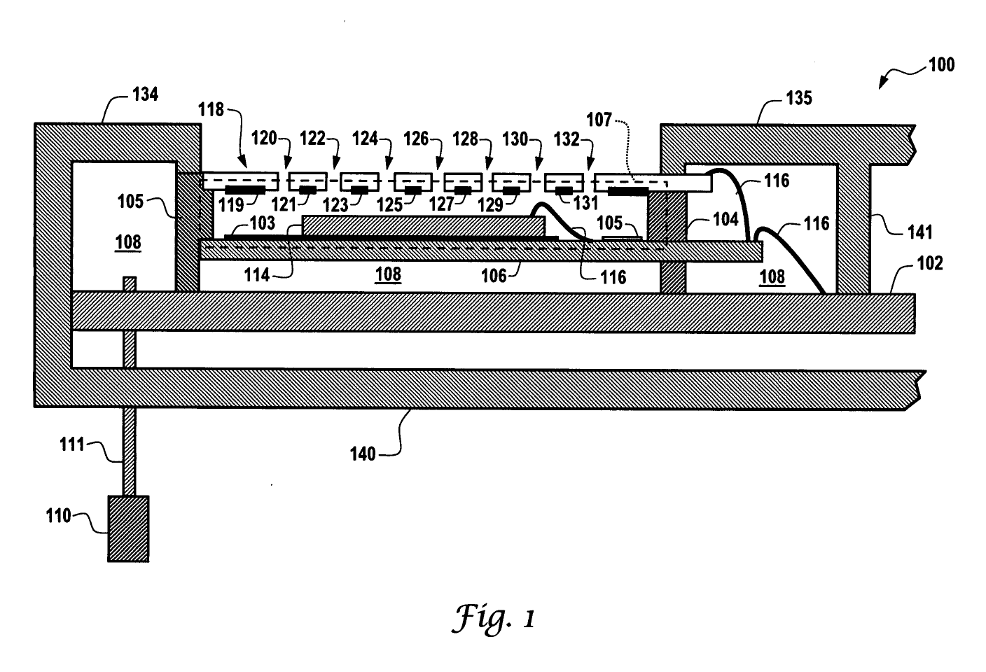

FIG. 1 illustrates a side view of a humidity sensor apparatus 100 that can be implemented in accordance with one embodiment. Apparatus 100 includes a humidity sensor 114 and a topside heater 118 comprising a material that permits diffusion of air through heater 118 and a bottom-side heater 106 located below humidity sensor 114. The topside heater 118 is located above humidity sensor 114 and includes a plurality of holes 120, 122, 124, 126, 128, 130 and 132. A sensing area 107 indicated by dashed lines in FIG. 1 is generally formed between the topside heater 118, the humidity sensor 114 and the bottom-side heater 106.

Topside heater 118 and bottom-side heater 106 together form a heater that surrounds the humidity sensor 114 and the sensing area 107. The sensing area 107 generally functions as a heat zone with minimal air circulation. Water vapor and fog are therefore allowed to diffuse into the heat zone of sensing area 107, which vaporizes condensed water droplets (e.g., fog) in order to measure relative humidity (RH) within 0% to 100% RH. The heater formed from topside heater 118 and bottom-side heater 106 thereby provides a heated environment within the sensing area 107 in order to evaporate water droplets that form within the sensing area 107 and reduce relative humidity to a measurable level and measure supersaturated air within the sensing area 107.

The humidity sensor apparatus 100 is capable of measuring relative humidity within a range of 0% to 100%. Thus, the humidity sensor 100, the heater (i.e., topside heater 118 and bottom-side heater 106), and the sensing area 107 enable measurement of a relative humidity greater than 100% within the sensing area 107 by providing a controlled, heater environment within a vicinity of the sensing area 107

In general, the topside heater 118 is configured from material that permits diffusion of air through the material of the topside heater 118. The topside heater 118 is associated with a thermistor formed from thermistor components 119, 121, 123, 125, 127, 129 and 131, while the bottom-side heater 106 is associated with a thermistor 103, 105. Additionally, a circuit board 102 can be connected to a heater support component 104, 105 for supporting the topside heater 118 and the bottom-side heater 106.

One or more insulating zones 118 are also provided between the circuit board 102 and the heater support component 104, 105. The heater support component 104, 105 can further be connected to and/or comprise a first frame 135 formed from a thermally conducting material and a second frame 124 supporting a filter material associated with the heater formed from topside heater 118 and bottom-side heater 106. Additionally, a plurality of low-thermal conductivity electrical leads 116 can be utilized to electrically connect the humidity sensor 114 to the circuit board 102, thereby allowing data to be transferred between the humidity sensor 114 and the circuit board 102.

An ambient temperature sensor 110 can be associated with the humidity sensor 114 and may be provided by a supporting arm 111. An unheated reference temperature sensor (not shown) can also be associated with the humidity sensor 114, such that the ambient temperature sensor and the unheated reference temperature sensor are utilized to relative humidity sensing data generated by the humidity sensor 114. Note that the first frame 135 includes a frame portion 141 that is bonded to or in contact with circuit board 102.

Note that at RH levels higher than 100%, water droplets are formed in suspensions (e.g., fog) and conventional relative humidity sensors fail to operate due to material limitations. The configuration of FIG. 1, on the other hand, enables measurements of RH greater than 100% RH with humidity sensor 114 (which is capable of measuring 0% to 100% RH sensitivity) by providing a controlled, heated environment in the vicinity of the sensing area 107, which can evaporate water droplets and reduce RH to a measurable level.

The heater formed by topside heater 118 and bottom-side heater 106 is constructed around humidity sensor 114 with topside heater 118 being made of a material that permits water droplets to vaporize, thereby allowing the relative humidity thereof to lower to a measurable level. An unheated reference temperature sensor (not shown in FIG. 1) can be placed in the super-saturated fog environment, while another temperature sensor 110 can be placed on or near the sensing surface in order to assist in correlated RH values and data collected from humidity sensor 114.

Additionally, an insulated base 140 can be mounted to the circuit board 202 to support bottom-side heater 106. Humidity sensor 114 can be bonded to bottom-side heater 106 with a relatively conductive material. Frame 134 can be connected to and/or form part of base 140. Frame 134 can also be connected to support component 105 in order to assist in supporting topside heater 118, which is porous. The second heater, i.e., bottoms-side heater 106 can optionally be connected or mounted to support component 116, which is bonded to another frame 135 when can then support a filter material that forms topside heater 118, depending upon design considerations.

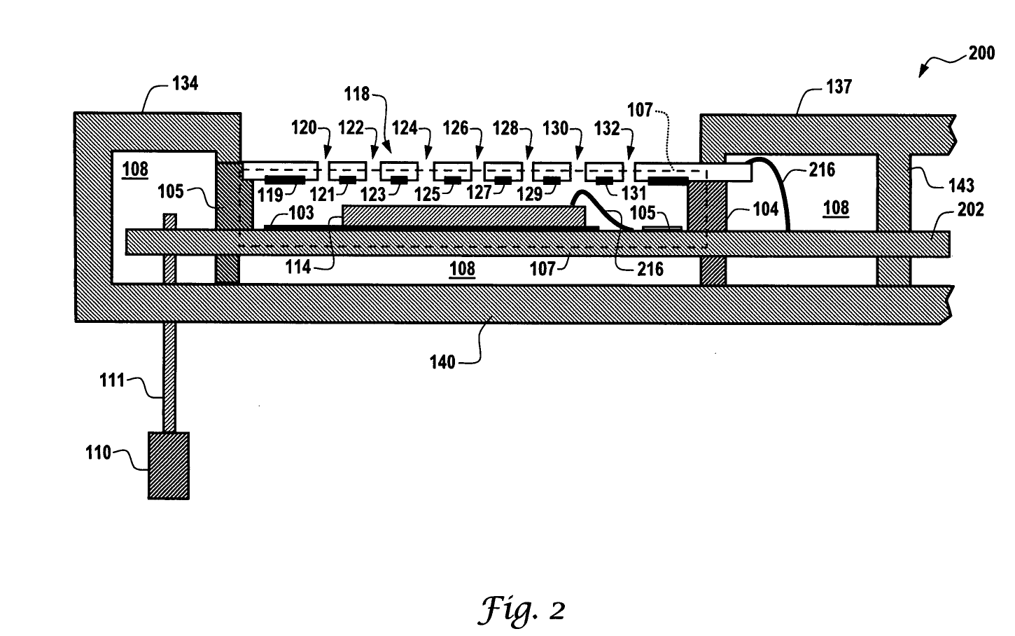

FIG. 2 illustrates a side view of a humidity sensor apparatus 200 that can be implemented in accordance with another embodiment. Note that in FIGS. 1-2, identical or similar parts are indicated by identical reference numerals. Thus, apparatus 200 of FIG. 2 is similar to the apparatus 100 of FIG. 1, with the exception of some additional and modified features. For example, apparatus sensor 200 includes a printed circuit board 202 that comes into contact with a frame portion 143 formed from a frame 137 that is analogous to frame 135 of FIG. 1.

A plurality of low thermal electrical conductivity leads 216 can be provided in the configuration of FIG. 1. In the alternative embodiment of apparatus 200, topside heater 118 can be formed from a ceramic material in which holes 120, 122, 124, 126, 128, 130, 132 can be formed in order to minimize airflow. Ceramic, being a conductive material, can heat water droplets that pass through one or more holes 120, 122, 124, 126, 128, 130, and 132 in order to vaporize such water droplets and reduce RH thereof to a measurable level.

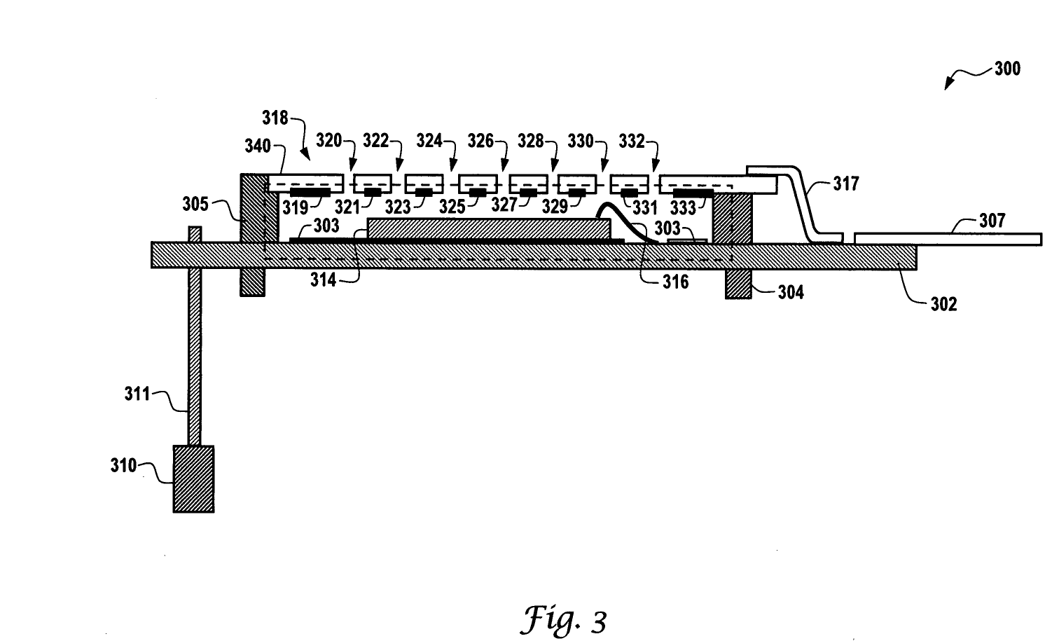

FIG. 3 illustrates a side view of a humidity sensor apparatus 300 that can be implemented in accordance with an alternative embodiment. Apparatus 300 is generally composed of a humidity sensor 314 capable of measuring relative humidity. A heater 318 is generally located about and proximate to the humidity sensor 314 wherein the heater 318 is composed material that permits a diffusion of air through said material of the heater 318. In general, heater 318 comprises a porous heater, which is also associated with thermistor components 319, 321, 323, 325, 327, 329, 331 and 133. Porous heater 318 is porous due to the presence of a plurality of holes 320, 322, 324, 326, 328, 330, 332.

Heater 318 thus comprises a top-side heater while a bottom-side or lower heater 303 is located generally below humidity sensor 314. The lower heater 303 along with circuit board 302 and thermistor components can provide low thermal conductivity to control temperature in the heat zone 340 indicated by dashed lines in FIG. 3. Heat zone 340 provides minimal air circulation and allows water vapor and fog to diffuse into zone 340, which vaporizes condensed water droplets (e.g., fog) in order to measure within 0% to 100% relative humidity. Additionally, a heater support portion 304, 305 can also be provided along with circuit board 302 and a platform 307. An ambient temperature sensor 310 (e.g., minimal thermal cross-talk with heaters) can also be provided and supported by a supporting arm 311. Additionally, low thermal conductivity electrical leads 316 and 317 can also be provided (e.g., wirebonds).

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A humidity sensing apparatus, comprising:
a humidity sensor capable of measuring relative humidity;
a heater located about and proximate to said humidity sensor wherein a portion of said heater comprises a material that permits a diffusion of air through said material of said heater, and
a sensing area formed between said heater and said humidity sensor, wherein said heater provides a heated environment within said sensing area in order to evaporate water droplets that form within said sensing area and reduce relative humidity to a measurable level and measure supersaturated air within said sensing area.

2. The apparatus of claim 1 wherein:
said humidity sensor is capable of measuring relative humidity within a range of 0% to 100%; and
said humidity sensor, said heater and said sensing area enable measurement of a relative humidity greater than 100% within said sensing area by providing a controlled, heater environment within a vicinity of said sensing area.

3. The apparatus of claim 1 wherein said heater comprises a topside heater formed above said humidity sensor a bottom-side heater located below said humidity sensor, wherein said topside heater comprises said material that permits diffusion of air through said material of said heater.

4. The apparatus of claim 3 wherein said topside heater is associated with a thermistor and said bottom-side heater is associated with a thermistor.

5. The apparatus of claim 3 further comprising:
a circuit board connected to at least one heater support component for supporting said topside heater and said bottom-side heater; and
at least one insulating zone formed between said circuit board and said at least one heater support component.

6. The apparatus of claim 5 wherein said at least one heater support component comprises a first frame formed from a thermally conducting material.

7. The apparatus of claim 5 wherein said at least one heater support components comprises a second frame supporting a filter material associated with said heater.

8. The apparatus of claim 5 further comprising a plurality of low-thermal conductivity electrical leads connecting said humidity sensor to said circuit board, thereby allowing data to be transferred between said humidity sensor and said circuit board.

9. The apparatus of claim 1 further comprising:
an ambient temperature sensor associated with said humidity sensor; and
an unheated reference temperature sensor associated with said humidity sensor, wherein said ambient temperature sensor and said unheated reference temperature sensor are utilized to relative humidity sensing data generated by said humidity sensor.

10. The apparatus of claim 1 wherein said humidity sensor comprises a ceramic material having a plurality of holes formed therein which minimize airflow thereof, such that said ceramic material is nonconductive and heats and vaporizes water droplets passing therethrough, thereby reducing said relative humidity to said measurable level.

10. A humidity sensing apparatus, comprising:
a humidity sensor capable of measuring relative humidity, wherein said humidity sensor is capable of measuring relative humidity within a range of 0% to 100%;
a heater located about and proximate to said humidity sensor wherein a portion of said heater comprises a material that permits a diffusion of air through said material of said heater, and
a sensing area formed between said heater and said humidity sensor, wherein said heater provides a heated environment within said sensing area in order to evaporate water droplets that form within said sensing area and reduce relative humidity to a measurable level and measure supersaturated air within said sensing area, such that said humidity sensor, said heater and said sensing area enable measurement of a relative humidity greater than 100% within said sensing area by providing a controlled, heater environment within a vicinity of said sensing area.

11. The apparatus of claim 10 further comprising:
an ambient temperature sensor associated with said humidity sensor; and
an unheated reference temperature sensor associated with said humidity sensor, wherein said ambient temperature sensor and said unheated reference temperature sensor are utilized to relative humidity sensing data generated by said humidity sensor.

12. The apparatus of claim 10 wherein said humidity sensor comprises a ceramic material having a plurality of holes formed therein which minimize airflow thereof, such that said ceramic material is nonconductive and heats and vaporizes water droplets passing therethrough, thereby reducing said relative humidity to said measurable level.

13. A humidity sensing method, comprising:
providing a humidity sensor capable of measuring relative humidity;
locating a heater about and proximate to said humidity sensor wherein a portion of said heater comprises a material that permits a diffusion of air through said material of said heater, and
forming a sensing area between said heater and said humidity sensor, wherein said heater provides a heated environment within said sensing area in order to evaporate water droplets that form within said sensing area and reduce relative humidity to a measurable level and measure supersaturated air within said sensing area.

14. The method of claim 13 wherein:
said humidity sensor is capable of measuring relative humidity within a range of 0% to 100%; and
said humidity sensor, said heater and said sensing area enable measurement of a relative humidity greater than 100% within said sensing area by providing a controlled, heater environment within a vicinity of said sensing area.

15. The method of claim 13 further comprising:
configuring said heater to comprise a topside heater and a bottom-side heater;
forming said topside heater above said humidity sensor; and
locating said bottom-side heater below said humidity sensor, wherein said topside heater comprises said material that permits diffusion of air through said material of said heater.

16. The method of claim 15 further comprising:
associating said topside heater with a thermistor; and
associating said bottom-side heater with a thermistor.

17. The method of claim 15 further comprising:
connecting a circuit board connected to at least one heater support component for supporting said topside heater and said bottom-side heater;
forming at least one insulating zone formed between said circuit board and said at least one heater support component.

18. The method of claim 15 further comprising configuring said at least one heater support component to comprise a first frame formed from a thermally conducting material and a second frame supporting a filter material associated with said heater.

19. The method of claim 15 further comprising connecting a plurality of low-thermal conductivity electrical leads said humidity sensor to said circuit board, thereby allowing data to be transferred between said humidity sensor and said circuit board.

20. The method of claim 13 further comprising:
associating an ambient temperature sensor with said humidity sensor; and
associating an unheated reference temperature sensor with said humidity sensor, wherein said ambient temperature sensor and said unheated reference temperature sensor are utilized to relative humidity sensing data generated by said humidity sensor.
